(19) United States
(12) Patent Application Publication
(10) Pub. No.: US 2017/0021451 A1
(43) Pub. Date: Jan. 26, 2017

(54) Trimming Device and Method for Cutting Metal Hollow Bodies

(71) Applicant: Hinterkopf GmbH, Eislingen (DE)

(72) Inventors: Stefan Drexler, Bad Uberkingen/Hausen (DE); Thomas Pfluger, Sussen (DE)

(21) Appl. No.: 15/074,320

(22) Filed: Mar. 18, 2016

(30) Foreign Application Priority Data
Mar. 20, 2015 (EP) 15000823.3

(51) Int. Cl. B23K 26/08; B23K 26/04; B23K 26/361; B23K 26/03

(52) U.S. Cl. CPC B23K 26/0823; B23K 26/03; B23K 26/04; B23K 26/361; B23K 2201/125

(57) ABSTRACT

A trimming device for metal hollow bodies, including a machine frame on which a workpiece round table is mounted for rotation about an axis of rotation and on which a cutting device is located, wherein the workpiece round table includes a plurality of holding devices designed for holding a metal hollow body each for carrying out a trimming operation, and wherein the cutting device is designed for providing a cutting beam, in particular a laser beam, for a contactless trimming operation on the metal hollow body, wherein a drive device is designed for providing a rotary step movement for the workpiece round table is assigned to the workpiece round table.

The invention relates to a trimming device for metal hollow bodies, in particular aerosol cans, the device comprising a machine frame on which a workpiece round table is mounted for rotation about an axis of rotation and on which a cutting device is located, wherein the workpiece round table comprises a plurality of holding devices designed for holding a metal hollow body each for carrying out a trimming operation, and wherein the cutting device is designed for providing a cutting beam, in particular a laser beam, for a contactless trimming operation on the metal hollow body.

A trimming device for metal hollow bodies is known from DE-OS 26 39 566. This trimming device comprises a workpiece round table on which is provided a plurality of holding mandrels designed for holding a metal hollow body each. The workpiece round table is designed for rotating about a centrally located axis of rotation. The holding mandrels are arranged such that the longitudinal axes of the cylindrical metal hollow bodies are oriented parallel to the axis of rotation. Furthermore, each holding mandrel is rotatable about a working axis oriented parallel to the axis of rotation of the workpiece round table. The metal hollow bodies on the holding mandrels are rotated about the working axes of the holding mandrels in a continuous rotary movement of the workpiece round table, resulting in a superposition of the two rotary movements. During this superposed movement, the metal hollow body is guided with a circumferential region past a bow-shaped cutter located radially on the outside and assigned to the workpiece round table. The engagement of the cutter with the circumferential region of the passing metal container and the superposition of the two rotary movements result in a trimming of the end of the respective metal container.

The invention is based on the problem of providing a trimming device and a method for trimming metal hollow bodies which facilitate a more accurate machining of the metal hollow bodies.

According to a first aspect of the invention, this problem is solved for a trimming device of the type referred to above, wherein a drive device designed for providing a rotary step movement for the workpiece round table is assigned to the workpiece round table.

The metal hollow bodies to be machined are preferably blanks for the production of aerosol cans, which are for example produced from steel in a deep-drawing process or from aluminium in a flow pressing process and which are substantially beaker-shaped. As a result of the selected production method, the metal hollow bodies do not have an edge which is precisely aligned relative to the central axis, in particular the axis of rotational symmetry, at the circumferential edge of the beaker-shaped contour which is remote from the base. Before any further processing steps for the metal hollow body, in particular before a drawing-in step, this edge has to be trimmed

Using the trimming device according to the invention, the trimming operation is a discontinuous process. The metal hollow bodies are received at the workpiece round table at a loading or infeed station and passed past the cutting device as part of the rotary step movement to perform the cutting operation and then conveyed to an unloading or discharge station, where they are removed from the workpiece round table. The cutting device is mounted on the machine frame in such a way that it machines the metal hollow body at a presettable machining position, which preferably coincides with a standstill position of the workpiece round table.

A rotary step movement comprises a sequence of swivelling movements of the workpiece round table about the axis of rotation, the consecutive swivelling movements being preferably performed with identical swivel angles. Between the swivelling movements the workpiece round table stops at least almost completely. In this standstill phase, the metal hollow bodies are machined, in particular trimmed, in at least one standstill position. The provision of a rotary step movement for the workpiece round table allows for a simple and cost-effective design of the cutting device, which is stationary relative to the machine frame and the metal hollow body at least during the cutting process, apart from potentially provided minor adjusting movements, and which does not have to be synchronised with the metal hollow body to be machined, as is for example known from EP 2 522 473 B1. Notwithstanding the irregular movement for the metal hollow bodies, a rotary step movement for the workpiece round table permits working with short cycle times for machining the metal hollow bodies when using a cutting device designed for providing a cutting beam, in particular a laser beam. The illustrated embodiment works on the assumption that up to 250 metal hollow bodies per minute can be trimmed using such a trimming device.

Advantageous further developments of the invention are the subject matter of the dependent claims.

It is expedient if the drive device is designed as a gearless electric direct drive. This facilitates a flexible adaptation of the rotary step movement for the workpiece round table to the manner and number of the machining processes to be carried out in the standstill phases and/or to the size of the metal hollow bodies and/or to the machining speed for the respective machining processes. An electric direct drive preferably comprises a stator connected to the machine frame and a rotor rotatably mounted on the stator and can be designed as an internal rotor motor or an external rotor motor. A rotary movement of the rotor, which may, for example, be a part of an asynchronous motor, relative to the stator is in the illustrated embodiment induced by the provision of electric energy which is converted into an electromagnetic travelling field to the stator, which may, for example, be a part of an asynchronous motor. Furthermore, with the aid of a direct drive a variable adaptation of an acceleration of the workpiece round table from the standstill phase to the rotary step movement and/or a deceleration of the workpiece round table from the rotary step movement to the standstill phase and/or a swivel angle for the rotary step movement can be freely selected within broad ranges.

In an advantageous further development of the invention, it is provided that the holding device comprises a clamping means which is mounted on the workpiece round table for rotation about a machining axis and which is designed for holding a region, in particular an outer region, of the metal hollow body. As a result of the rotatable mounting of the clamping means, the metal hollow body held in the clamping means can be rotated about a body axis, in particular an axis of rotational symmetry. In this way, a continuous circular, preferably cylindrical, surface region of the metal hollow body can be moved past the cutting device to perform the required trimming operation. Accordingly, it is preferably provided that the machining axis of the clamping means at least substantially corresponds to the body axis of the metal hollow body and is in particular concentric therewith. The clamping means preferably is a collet chuck having at least one elastic region designed for contacting the metal hollow body, in particular at an outer region of the metal hollow body. In the illustrated embodiment, the clamping means comprises a clamping insert which is designed as a slotted plastic part by way of example and which ensures a passive, elastic and therefore non-positive location of the metal hollow body in the clamping means. Alternatively, the clamping means can be provided with an actuator which facilitates an optional increase or reduction of clamping forces applied to the metal hollow body as a function of the machining process.

In a further variant of the invention, it is provided that the holding device comprises a holding means which is located adjacent to the clamping means and extends along the machining axis and which has an adhesion surface for a metal hollow body, which extends along the machining axis and has a cylindrical section profiling, the profile axis of the adhesion surface being oriented parallel, in particular concentric with or eccentric relative to, the machining axis.

A profiling of the adhesion surface is matched to the outer surface of the metal hollow body, which preferably has a cylindrical outer surface, so that the profiling of the adhesion surface may, for example, have the shape of a cylindrical sleeve section. A profile axis of the adhesion surface extends parallel, in particular concentric with or eccentric relative to, the machining axis of the clamping means. The profiling of the adhesion surface and the position of the machining axis of the clamping means are preferably matched to the geometry of the metal hollow body in such a way that, if the metal hollow body is displaced linearly from the adhesion surface into the clamping means, there is at least a slight distance between the outer surface of the metal hollow body and the adhesion surface, in order to avoid a frictional contact with the adhesion surface during the following rotation of the metal hollow body.

The adhesion surface of the holding means is in particular used during the delivery of the metal hollow bodies to the workpiece round table, when the metal hollow bodies are, for example, taken off a conveyor belt or chain with the aid of a so-called loading star and supplied to the workpiece round table. In this process, the loading star has the purpose of supplying the metal hollow bodies, which are substantially made available continuously, to the respective holding device during the standstill phases of the workpiece round table. Since, at least at higher machining speeds, a direct delivery of the metal hollow body into the respective clamping means is impossible during a single standstill phase because of lack of time, the metal hollow body is first moved by the loading star to the respective adhesion surface of the holding device. This is configured such that the metal hollow body reliably adheres to the holding means during the following rotary step movement and can be inserted into the respective clamping means, for example during a subsequent standstill phase. When machining metal hollow bodies containing a ferromagnetic alloy, it can, for example, be provided that the adhesion surface is fitted with electrically operated solenoids and/or permanent magnets for magnetic adhesion to the holding means. When machining metal hollow bodies without magnetic properties, the metal hollow bodies are preferably made to adhere to the adhesion surface by means of a vacuum.

For this purpose, recesses which communicate fluidically with a suction passage formed in the workpiece round table and which are designed for applying a vacuum to the adhesion surface for holding the metal hollow body preferably pass through the adhesion surface. In a particularly preferred embodiment, it is provided that the suction passage is continued on the machine frame and connected to a suction device, in particular an extraction fan. It may, for example, be further provided that the suction passage on the machine frame and the suction passage in the workpiece round table are connected to one another for fluidic communication by a sealing rotary connection.

It is advantageous if the clamping means mounted on the workpiece round table for rotation about the machining axis comprises a friction wheel and if a belt drive with a continuous drive belt, which is designed for coupling a motion onto the friction wheel, is assigned to the workpiece round table. By an interaction between the friction wheel assigned to the clamping means and the driven drive belt of the belt drive, a rotary movement of the clamping means can be initiated in a simple way without having to provide a separate drive for each clamping means. The belt drive is preferably equipped with an electric motor which effects a preferably continuous orbital movement of the drive belt. The friction wheel can in particular be located on a side of the clamping means which is opposite the holding means and is, for example, cylindrical, a central axis of the friction wheel being oriented concentrically with the machining axis of the clamping means.

It is expedient if the belt drive is designed for simultaneously coupling a motion onto several, in particular two, clamping means and comprises two deflection pulleys, the axes of rotation of which are arranged in such a way in the radial direction outside at a distance from a perimeter around the friction wheels of the workpiece round table that the drive belt contacts several friction wheels between the two deflection pulleys. It is preferably provided that the belt drive is mounted on the machine frame in such a way that the drive belt can make rotate not only the clamping means and the metal hollow body located therein, which are opposite the cutting device, but also at least the adjacent clamping means, which is brought into position opposite the cutting device during the next rotary step movement of the workpiece round table. In this way, it is ensured that the metal hollow body is already accelerated to the rotational speed required for the cutting process when arriving at the cutting device, so that a faster machining of the metal hollow bodies can be ensured. In this context, it is advantageous if the flexible drive belt is, with the aid of deflection pulleys of the belt drive, guided in such a way that, without a presence of the friction wheels at the workpiece round table, it forms a secant relative to a circle concentric with the axis of rotation, on which circle the machining axes of the clamping means are located. Owing to the radial distance of the deflection pulleys for the drive belt from a perimeter for the friction wheels, it is ensured that there is no immediate contact between the friction wheels on the one hand and the deflection pulleys on the other hand; on the contrary, the friction wheels exclusively bear against the flexible drive belt.

In a further variant of the invention, it is provided that a push-in plunger which is capable of linear movement parallel to the axis of rotation and designed for providing a push-in movement for the metal hollow body from the adhesion surface into the clamping means is provided on the machine frame. The push-in plunger is preferably located at a standstill position for the workpiece round table which immediately follows the standstill position where the respective metal hollow body is fed to the associated holding means of the holding device. In the illustrated embodiment, the push-in plunger is designed for applying a compressive force to a base region of the beaker-shaped metal hollow body in order to push the metal hollow body located on the holding means into the respective clamping means. Alternatively, it can be provided that the push-in plunger is designed for introducing a force into the opening region of the metal hollow body. It is preferably provided that the push-in plunger is driven by a linear actuator, in particular a fluid cylinder, or that it is designed as a direct part of a piston rod of a fluid cylinder.

In an advantageous further development of the invention, it is provided that an ejection plunger which is mounted for linear movement parallel to the axis of rotation and designed for providing an ejection movement for the metal hollow body from the clamping means is assigned to each clamping means, and that a control cam for the ejection plungers, against which end regions of the ejection plungers bear, is formed on the machine frame. The ejection plunger has the purpose of pushing the metal hollow body out of the respective clamping means at the unloading station of the workpiece round table after the machining process, thereby providing access to the metal hollow body for a conveying device, in particular an unloading star. By way of example, it can be provided that the metal hollow body is brought into contact with the holding means with the aid of the ejection plunger, from where it can be removed and carried away by the conveying device.

It is preferably provided that a cutting axis of the cutting device as defined by the cutting beam extends at an angle in a range of 60 degrees to 120 degrees, in particular 90 degrees, to the machining axis. The cutting axis therefore corresponds to the beam direction of the cutting beam emitted by the cutting device. Depending on the orientation of the cutting beam, a cutting edge at the metal hollow body will then optionally be either perpendicular to the machining axis or extend at an angle deviating from 90 degrees to the machining axis. It can, for example, be provided that the cutting axis is oriented relative to the metal hollow body in such a way that there is an inward-oriented conical taper for the wall of the metal hollow body in the opening region of the metal hollow body; this makes a subsequent machining of the metal hollow body easier, for example in the course of a necking process.

It is advantageous if an adjusting device designed for an adjustment of a relative position between the workpiece round table and the cutting device along the axis of rotation of the workpiece round table is assigned to the machine frame. With the aid of the adjusting device, which may be a fluidically or electrically operated actuator, in particular an electric spindle drive, a cutting position for the cutting device relative to the metal hollow bodies to be located at the workpiece round table can be adjusted. It is, for example, possible to adjust the length of the trimmed the metal hollow bodies.

A sensor means for detecting at least one physical property of the metal hollow body, in particular a temperature or linear expansion of the metal hollow body, is preferably assigned to the holding device for providing a sensor signal, and a control unit is designed for processing the sensor signal and for providing a control signal to an actuator, the actuator being coupled to the adjusting device for an automated adjustment of a cutting position. As the trimmed metal hollow bodies are usually subjected to further machining processes in which the overall length of the respective metal hollow body is highly important, for example to a subsequent necking process for the metal hollow bodies, a precise preset tolerance has to be observed for overall length.

With the aid of the sensor means, which may in particular be a contactless temperature sensor, a potential above-average or below-average temperature and an associated expansion of the respective metal hollow body can be detected and taken into account in the cutting process. For this purpose, it is provided that a sensor signal provided by the sensor means is processed in the control unit and a potentially necessary compensation of the overall length for the respective metal hollow body is carried out by changing the relative position between the workpiece round table and the cutting device. For this purpose, the control unit provides a corresponding control signal to an actuator which is coupled to the adjusting device and accordingly allows a displacement of the cutting device relative to the workpiece round table.

According to a second aspect of the invention, the problem of the invention is solved by a method for trimming a metal hollow body. In this, a cutting device designed for providing a cutting beam, in particular a laser beam, for a contactless trimming operation on the metal hollow body is operated in the following way: supplying the metal hollow body to a clamping means rotatably located at a workpiece round table at a loading position, performing at least one rotary step movement for the workpiece round table to move the metal hollow body from the loading position to a moving position, inducing a continuous rotary movement into the metal hollow body located on the clamping means, performing at least one rotary step movement for the workpiece round table to move the metal hollow body from the moving position to a cutting position, executing the contactless cutting operation while maintaining the continuous rotary movement for the metal hollow body located on the clamping means, performing at least one rotary step movement for the workpiece round table to move the metal hollow body from the cutting position to an unloading position and unloading the metal hollow body.

In an advantageous further development of the method, it is provided that a cutting length for the metal hollow body is adjusted, in particular in response to a sensor signal of a sensor means designed for detecting at least one physical property of the metal hollow body, in particular a temperature or linear expansion of the metal hollow body, by a relative displacement of the cutting device versus the workpiece round table along the axis of rotation of the workpiece round table.

An advantageous embodiment of the invention is illustrated in the drawing, of which:

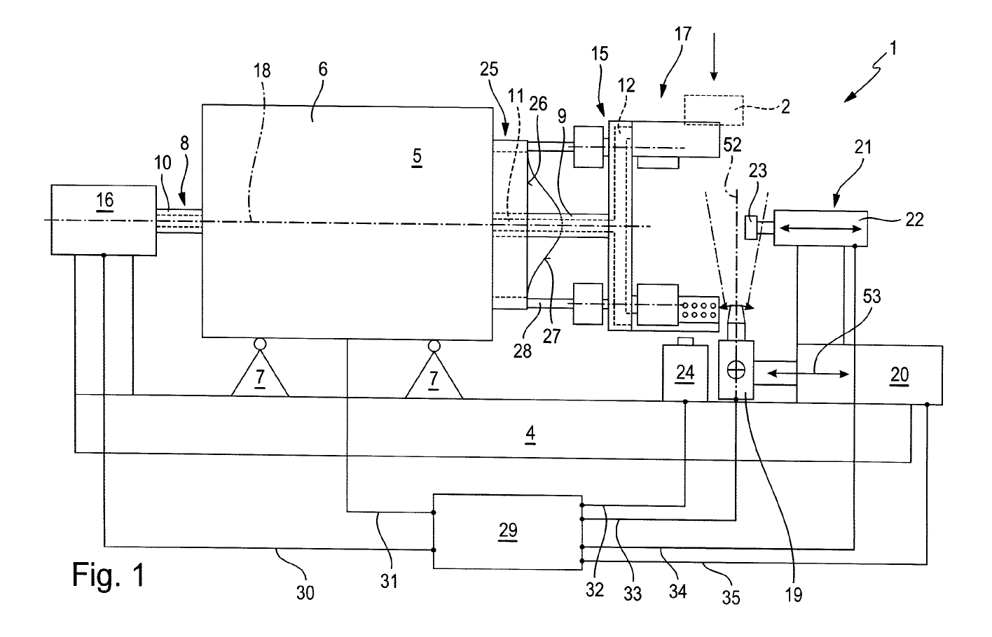

FIG. 1 is a diagrammatic front view of a trimming device illustrated in a greatly simplified way,

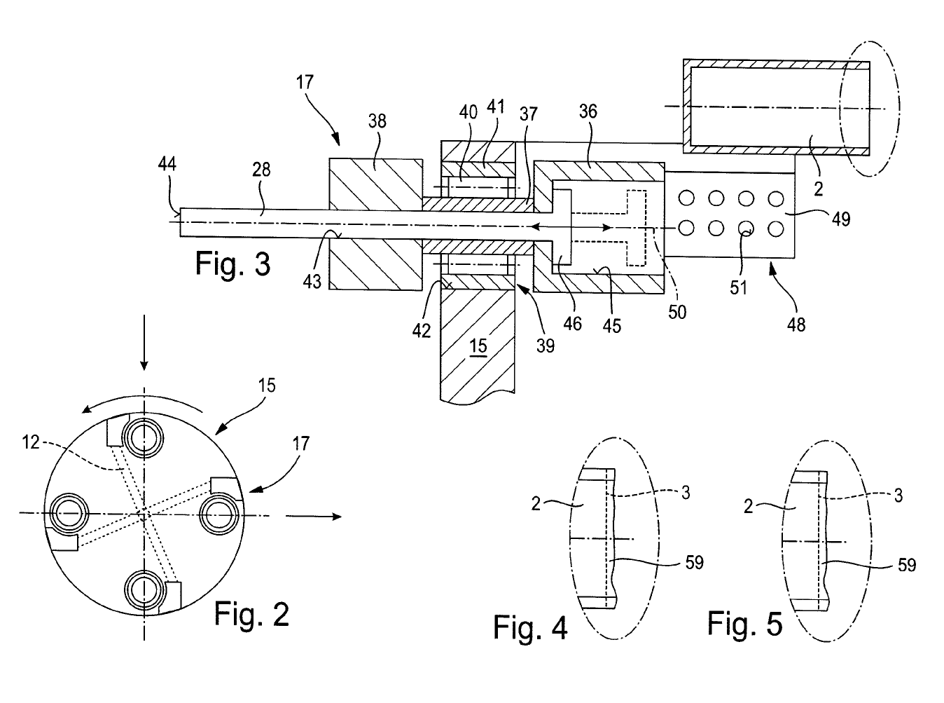

FIG. 2 is a diagrammatic side view of a workpiece round table of the trimming device according to FIG. 1,

FIG. 3 is a detailed illustration of the workpiece round table according to FIG. 2,

FIG. 4 is a detailed illustration of an opening region of the metal hollow body with a first embodiment of a planned cutting edge,

FIG. 5 is a detailed illustration of an opening region of the metal hollow body with a second embodiment of a planned cutting edge, and

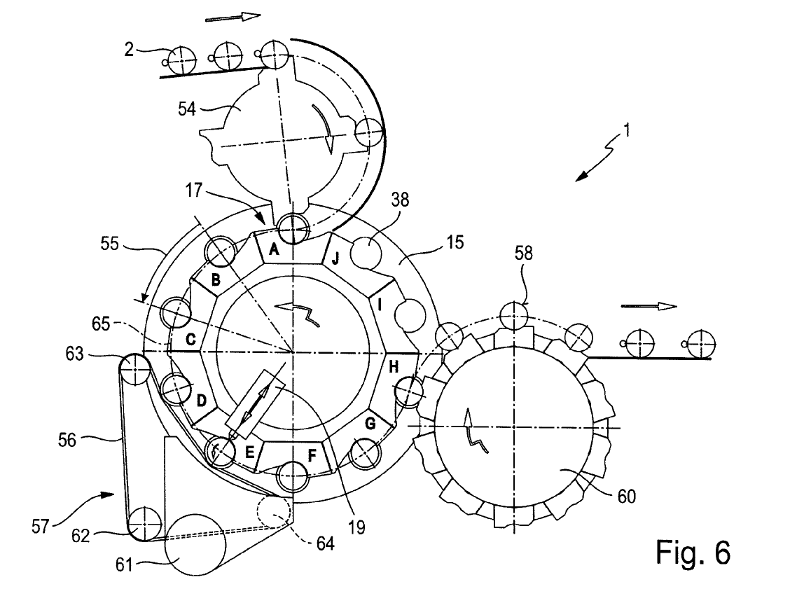

FIG. 6 is a detailed illustration of a side view of the trimming device according to FIG. 1.

A trimming device 1 illustrated purely diagrammatically and in a greatly simplified way in FIG. 1 is used for trimming metal hollow bodies 2, in particular cylindrical sleeve-shaped blanks open on one side for aerosol cans with a flat or concavely embossed base region. Purely by way of example, the following description of the trimming device 1 is based on the assumption that the metal hollow bodies 2 are supplied in the vertical direction from above by means of a conveying device not shown in detail and, according to the illustration of FIG. 1, carried away in the horizontal direction backwards into the image plane by a conveying device likewise not shown. This does not exclude other possibilities of supplying and removing the metal hollow bodies 2.

The trimming device 1 has the purpose of providing an edge region shown in detail in FIGS. 3, 4 and 5 at the opening of the cylindrical sleeve-shaped metal hollow body 2 with a presettable cutting edge 3, which is required for a precise further processing of the metal hollow body 2 in machines not shown in the drawing, in particular in a necking machine.

Purely by way of example, the trimming device 1 comprises a machine frame 4, which may for example be a machine bed made of metal and is plate-shaped in the illustrated embodiment. A drive device 5, which is an electric direct drive, in particular an asynchronous motor, by way of example, is immovably mounted on the machine frame 4. In the illustrated embodiment, the drive device 5 comprises a tubular stator 6 located on the machine frame 4 by bearing blocks 7. Rotatably installed into the stator 6, a rotor not shown in detail is connected to a drive shaft 8. Shaft sections 9, 10, the function of which will be explained in greater detail below, project on both sides of the stator 6 beyond the stator 6.

In the illustrated embodiment, it is provided that a suction passage 11 connected in the region of the front shaft section 9 to communicate with suction passages 12 of a workpiece round table 15, which is circular in the illustrated embodiment, passes through at least almost the entire length of the drive shaft 8. In the region of the rear shaft section 10, the suction passage is connected for fluidic communication to a suction device 16, which may be an extraction fan by way of example. The suction device 16 has the purpose of providing a vacuum at the suction passages 11, 12.

The workpiece round table 15 shown in FIGS. 1 to 3 and non-rotatably connected to the shaft section 9 supports a plurality of holding devices 17, each of which is designed for temporality holding metal hollow bodies 2 for executing the respective machining operation. To simplify the illustration, FIGS. 1 to 3 show only a few holding devices 17; a realistic arrangement of holding devices 17 can be seen in FIG. 6, which will be explained in greater detail below.

With the aid of the drive device 5, the workpiece round table 15 can be made to rotate about an axis of rotation 18, the rotation being a rotary step movement, i.e. a sequence of pivoting movements and standstill phases, in particular in a single direction. In the course of this sequence of rotary step movements, the metal hollow bodies 2 can be conveyed past a cutting device 19, the cutting device 19 being designed for providing a cutting beam, in particular a laser beam, for machining the metal hollow body 2.

By way of example, it is provided that the cutting device 19 is attached to an adjusting device 20 designed as a linear actuator, in particular an electric spindle drive, with the aid of which the cutting device 19 can be displaced axially along the axis of rotation 18 in order to provide a cutting position of the cutting device 19 relative to the metal hollow bodies 2 held in the holding device 17. In addition, it can be provided that the cutting device 19 can be pivoted about a pivoting axis oriented normal to the plane of view of FIG. 1, for varying the orientation of the cutting axis 52 relative to the metal hollow body 2. In addition or as an alternative, there may further be provided an adjusting facility for the cutting device 19 along the cutting axis 52 for adapting to different diameters of the metal hollow bodies 2, as indicated by the double-headed arrow 53 in FIG. 1.

By way of example, it can further be provided that a push-in device 21, which essentially comprises an actuator 22, in particular a pneumatic cylinder, and a push-in plunger 23 coupled to the actuator 22, is mounted on the machine frame 4. The push-in plunger 23 can be moved from the inoperative position shown in the drawing in a linear motion, in particular parallel to the axis of rotation 18, towards the holding device 17 for pushing the metal hollow body 2 into the holding device 17 for the planned machining step.

Additionally, it may be provided that a sensor means 24, which may for example be a contactless temperature sensor designed for detecting a temperature of the metal hollow body 2, is provided in the region of the cutting device 19.

At an end face of the stator 6 facing the workpiece round table 15, an annular control contour 25 is provided purely by way of example. In the region of a front annulus half placed in front of the drive shaft 8 according to FIG. 1, the control contour 25 has a flat end face 26. In the region of a rear annulus half placed behind the drive shaft 8 according to FIG. 1, the control contour 25 has a curved end face 27 with a distance from the workpiece round table 15 which is reduced in some regions. Against the end faces 26, 27 of the control contour 25 bear ejection plungers 28 associated with the holding devices 17; as a result of interactions with the flat end face 26 and the curved end face 27, these are displaced in a linear motion parallel to the axis of rotation 18 during a rotary step movement of the workpiece round table 15. By way of example, it is provided that the ejection plungers 28 are always pressed against the end faces 26, 27 by a preloaded spring device not shown in detail. The operation of the ejection plungers 28 is explained in greater detail with reference to FIG. 3.

For a coordinated operation of the trimming device 1, a control unit 29 is provided, which is connected via control lines 30 to 35 to the conveying device 16, the drive device 5, the sensor means 24, the cutting device 19, the actuator 22 and the adjusting device 20 and which is designed for providing control signals to the respectively connected components. The control unit 29 can further be designed for processing sensor signals provided by the sensor means 24 and, if applicable, by further sensor means not shown in detail in the other components, for example a rotary encoder of the drive device 5 and/or a position sensor of the actuator 22 and/or the adjusting device 20, in order to facilitate a controlled operation for one or more of the components 5, 16, 19, 20, 22.

As can be seen in the detailed diagrammatic view of FIG. 3, the holding device 17 comprises a beaker-shaped clamping means 36 for the location of the metal hollow bodies 2, a shaft section 37 passing through the workpiece round table 15, which is plate-shaped in the illustrated embodiment, and a friction wheel 38 non-rotatably connected to the shaft section 37. The shaft section 37 is rotatably bearing-mounted in the workpiece round table 15; for this purpose, an antifriction bearing 39 is provided, its rolling bodies 40 rolling on a cylindrical outer surface of the shaft section 37 and on a cylindrical inner surface of a bearing race 41. In the illustrated embodiment, the bearing race 41 is pressed in a stationary arrangement into a recess 42 of the workpiece round table 15.

The ejection plunger 28 is accommodated for linear and rotary movement in a recess 43, which passes through the clamping means 36, the shaft section 37 and the friction wheel 38 and, as described above, bears with an end face 44 opposite the clamping means 36 against the end faces 26, 27 of the control contour 25. In the recess 45 of the clamping means 36, which is cylindrical in the illustrated embodiment, the ejection plunger 28 has a disc-shaped contact region 46 provided for surface contact with a base region 47 of the metal hollow body 2. This facilitates a planar introduction of force from the ejection plunger 28 into the metal hollow body 2 when the ejection plunger 28 contacts the curved end face 27 of the control cam 25 and carries out a linear displacement along the axis of rotation 18 as a result of the fact that the distance between the end face 27 and the workpiece round table 15 is reduced in some regions.

In addition to the rotatably mounted and non-rotatably connected combination of clamping means 36, shaft section 37 and friction wheel 38, the holding device 17 comprises a holding means 48 secured to the workpiece round table 15 in a stationary manner. As can be seen in FIG. 2 in particular, the holding means 48 is provided with a concave profiling in the shape of a cylindrical section, which extends with a constant cross-section along the axis of rotation of the clamping means 36, which is also described as machining axis 50. The profiling 49 serves as an adhesion surface for the temporary adhesion of the metal hollow bodies 2 before they are pushed into the clamping means 36. For this purpose, the holding means 48 has, in the region of the profiling 49, a plurality of recesses 51, which are in fluidic communication with the suction passages 11, 12 in a manner not shown in detail and can therefore, be directly subjected to a vacuum by the conveying device 16. By way of example, it is provided that the profiling 49 is arranged to be concentric with the recess 45 of the clamping means 36, but has a larger radius than the recess 45. A metal hollow body 2 adhering to the profiling 49 is therefore radially displaced into the recess 45 of the clamping means 36 in a push-in process, whereby it is ensured that there will be no contact between the metal hollow body 2 and the profiling 49 during a subsequent rotation of the clamping means 36 with the metal hollow body 2 located therein.

FIG. 6 does not show another embodiment of the invention, but only in greater detail the components indicated diagrammatically in FIGS. 1 to 5, so that the same references are used both in FIG. 6 and in FIGS. 1 to 5. Whereas FIG. 1 assumes a radially outward arrangement of the cutting device 19 for clarity, the realistic depiction of FIG. 6 provides that the cutting device 19 acts on the metal hollow bodies 2 in the radial direction from inside.

As already described with reference to FIG. 1, FIG. 6 likewise shows by way of example a delivery of metal hollow bodies 2 on a top side of the workpiece round table 15 with the aid of a loading star 54 to the profiling 49, also described as adhesion surface, of the holding device 17 at position A. In order to ensure that the metal hollow body 2 is securely located on the holding device 17, a vacuum is always applied to the adhesion surface, i.e. both during the rotary step movements and during the standstill times; this is provided via the suction passages 11, 12 and the suction device 16 shown in greater detail in FIGS. 1 and 2.

An adhesive effect is preferably chosen by applying a vacuum to the adhesion surface in such a way that the metal hollow body 2 remains reliably located on the holding device 17 even during a rotary step movement about a swivel angle 55, in the course of which the holding device 17 is pivoted from position A—also described as loading position—to position B. As soon as the holding device 17 reaches position B from position A, the metal hollow body 2 can be inserted into the clamping means 36 with the aid of the push-in plunger 23 not shown in FIG. 6 but known from FIG. 1, where it is preferably held non-positively.

This is followed by further rotary step movements, in the course of which the holding device 17 arrives at position D, also described as movement position. At the end of this rotary step movement, a frictional contact is created between the friction wheel 38 and a continuously driven drive belt 56 of a belt drive 57, inducing a rotary movement of the clamping means 36 and the metal hollow body 2 located therein about the machining axis 50. In a further rotary step movement into position E, also described as cutting position, the metal hollow body 2 is placed opposite the cutting device 19 and then held at least substantially continuously in the rotary movement about the machining axis 50 with the aid of the belt drive 57. The activation of the cutting device 19 is followed by a trimming process for the upper edge of the metal hollow body 2; depending on an orientation of the cutting axis 52 relative to the axis of rotation 18, this results in a cutting process as shown in FIG. 4 or 5 by way of example. It is preferably provided that an activation duration for the cutting device 19 is adjusted such that the metal hollow body 2 covers a rotary angle range which is at least greater than 360 degrees during the an activation duration of the cutting device 19, so that the cutting beam can completely sweep over the outer surface 58 of the metal hollow body 2.

While surplus material is being separated from the metal hollow body 2, the detached ring as shown diagrammatically in FIGS. 4 and 5 to the right of the indicated cutting line can be conveyed in a discharge passage, in particular by compressed air. The metal hollow body 2, which continues to be held in the holding device 17 and is now trimmed, is, by way of example, moved in the course of three further rotary step movements from position E to position H, also described as unloading position, and thus to an unloading star 60. The interaction between the ejection plunger 28 not visible in FIG. 6, but shown in detail in FIG. 3 and the control cam 25 likewise not visible in FIG. 6, but visible in FIG. 1 results in a linear displacement of the ejection plunger 28, with the result that the metal hollow body 2 is pushed out of the clamping means 36 and can be carried away by the unloading star 60. The above functional positions A, D, E, H can obviously be arranged at the workpiece round table 15 with a different pitch and/or with further or fewer intermediate positions.

Owing to the use of the drive device 5 designed as an electric direct drive, parameters such as an acceleration from the standstill position to the rotary step movement and/or a deceleration from the rotary step movement to the next standstill position and/or a clock rate and/or step width for the rotary step movements can be adjusted within certain limits without having to make mechanical changes to the drive device 5. The drive devices for the rotary movements of the loading star 54 and the unloading star 60, which are not shown in the drawing, are preferably also designed as direct drives or servomotors, in particular asynchronous motors, and comprise rotary encoders not shown in the drawing, which can be coupled to the control unit 29 for a synchronised movement of all conveying components 5, 15, 54 and 60.

The belt drive 57 is also equipped with an electric drive motor 61, which is coupled, in a way not shown in detail, to the control unit 29 in order to adapt an orbital velocity of the drive belt 56 to the requirements of the cutting device 19. In the illustrated embodiment, a friction roller of the drive motor 61, which is not shown in the drawing, acts on the drive belt 56, inducing its orbital movement. The drive belt 56 is further guided at deflection pulleys 62, 63 and 64, which in the illustrated embodiment are arranged in a triangle, the drive belt 56 being guided by the deflection pulleys 62 and 63 in such a way that, without contact with the friction wheels 38 of the respective holding devices 17, it would form a secant for a perimeter around the friction wheels 38 and for a circle through the machining axes 50. This ensures that the drive belt 56, owing to its elastic properties, facilitates a frictional introduction of movement into the respective clamping means 36 by interacting with the friction wheels 38.

The deflection pulleys 62 and 63 are preferably arranged in the radial direction outwards at a distance from the perimeter of the friction wheels 38 in such a way that a direct contact with the friction wheels 38 is avoided. Purely by way of example, it can be provided that, in a rotary step movement of the holding device 17 from position C to position D, the clamping means 36 with the metal hollow body 2 held therein is accelerated by frictional contact with the drive belt 56. In the rotary step movement from position D to position E, the friction wheel remains in frictional contact with the drive belt 56, so that the rotation of the clamping means 36 about the machining axis 50, which is required for the cutting process, is already ensured when reaching position E, and the cutting process can be performed immediately with the aid of the cutting device 19.

1. A trimming device for metal hollow bodies, the device comprising a machine frame on which a workpiece round table is mounted for rotation about an axis of rotation and on which a cutting device is located, wherein the workpiece round table comprises a plurality of holding devices designed for holding a metal hollow body each for carrying out a trimming operation, and wherein the cutting device is designed for providing a cutting beam, for a contactless trimming operation on the metal hollow body and wherein a drive device designed for providing a rotary step movement for the workpiece round table is assigned to the workpiece round table.

2. A trimming device according to claim 1, wherein the drive device is designed as a gearless electric direct drive and/or the cutting device is designed for providing a laser beam.

3. A trimming device according to claim 1, wherein the holding device comprises a clamping means, which is mounted on the workpiece round table for rotation about a machining axis and which is designed for holding a region, of the metal hollow body

4. A trimming device according to claim 3, wherein the holding device comprises a holding means, which is located adjacent to the clamping means and extends along the machining axis and which has an adhesion surface for a metal hollow body, which extends along the machining axis and has a cylindrical section profiling, the profile axis of the adhesion surface being oriented parallel, to, the machining axis.

5. A trimming device according to claim 4, wherein recesses, which communicate fluidically with a suction passage formed in the workpiece round table and which are designed for applying a vacuum to the adhesion surface for holding the metal hollow body, pass through the adhesion surface.

6. A trimming device according to claim 3, wherein the clamping means mounted on the workpiece round table for rotation about the machining axis comprises a friction wheel, and wherein a belt drive with a continuous drive belt, which is designed for coupling a motion onto the friction wheel, is assigned to the workpiece round table.

7. A trimming device according to claim 6, wherein the belt drive is designed for simultaneously coupling a motion onto several clamping means and comprises two deflection pulleys, the axes of rotation of which are arranged in such a way in the radial direction outside at a distance from a perimeter around the friction wheels of the workpiece round table that the drive belt contacts several friction wheels between the two deflection pulleys.

8. A trimming device according to claim 3, wherein a push-in plunger, which is capable of linear movement parallel to the axis of rotation and designed for providing a push-in movement for the metal hollow body from the adhesion surface into the clamping means, is provided on the machine frame.

9. A trimming device according to claim 3, wherein an ejection plunger, which is mounted for linear movement parallel to the axis of rotation and designed for providing an ejection movement for the metal hollow body from the clamping means, is assigned to each clamping means, and wherein a control cam for the ejection plungers, against which end regions of the ejection plungers bear, is formed on the machine frame.

10. A trimming device according to claim 1, wherein a cutting axis of the cutting device as defined by the cutting beam extends at an angle in a range of 60 degrees to 120 degrees to the machining axis.

11. A trimming device according to claim 1, wherein an adjusting device designed for an adjustment of a relative position between the workpiece round table and the cutting device along the axis of rotation of the workpiece round table is assigned to the machine frame.

12. A trimming device according to claim 1, wherein a sensor means for detecting at least one physical property of the metal hollow body is assigned to the holding device for providing a sensor signal, and wherein a control unit is designed for processing the sensor signal and for providing a control signal to an actuator, the actuator being coupled to the adjusting device for an automated adjustment of a cutting position of the cutting device.

13. A method for trimming a metal hollow body with a cutting device designed for providing a cutting beam for a contactless trimming operation on the metal hollow body, the method comprising the steps of: supplying the metal hollow body to a clamping means rotatably located at a workpiece round table at a loading position; performing at least one rotary step movement for the workpiece round table to move the metal hollow body from the loading position to a moving position; inducing a continuous rotary movement into the metal hollow body located on the clamping means; performing at least one rotary step movement for the workpiece round table to move the metal hollow body from the moving position to a cutting position; executing the contactless cutting operation while maintaining the continuous rotary movement for the metal hollow body located on the clamping means; performing at least one rotary step movement for the workpiece round table to move the metal hollow body from the cutting position to an unloading position and unloading the metal hollow body.

14. A method according to claim 13, wherein a cutting length for the metal hollow body is adjusted by a relative displacement of the cutting device versus the workpiece round table along the axis of rotation of the workpiece round table.
